(19) United States
(12) Patent Application Publication
(10) Pub. No.: US 2016/0086110 A1
(43) Pub. Date: Mar. 24, 2016

(54) SYSTEMS AND METHODS FOR WORKFLOW ANALYSIS

(71) Applicants: Tin Kam Ho, Millburn, NJ (US); Steve Fortune, Summit, NJ (US); John Hobby, Piscataway, NJ (US); Gordon Wilfong, Florham Park, NJ (US); Chun-Nam Yu, Jersey City, NJ (US)

(72) Inventors: Tin Kam Ho, Millburn, NJ (US); Steve Fortune, Summit, NJ (US); John Hobby, Piscataway, NJ (US); Gordon Wilfong, Florham Park, NJ (US); Chun-Nam Yu, Jersey City, NJ (US)

(21) Appl. No.: 14/489,936

(22) Filed: Sep. 18, 2014

(51) Int. Cl. G06Q 10/06

(52) U.S. Cl. CPC G06Q 10/0633

(57) ABSTRACT

A system and method for workflow analysis includes an evaluation module executing on a processor that receives execution logs including records of workflow paths traversed. The evaluation module correlates at least one workflow step with a target metric and generates an importance score for the at least one workflow step based on the correlation with the target metric.

### FIELD OF THE INVENTION

The present invention relates to workflow analysis and, more particularly, to customer service workflow analysis.

### BACKGROUND

Workflows provide sets of steps to guide agents, such as customer service representatives, sales representatives, service technicians or the like, through interactions with customers. The workflow path or sequence of steps traversed through a workflow for a particular interaction may depend upon how the particular interaction, itself, progresses.

### SUMMARY

According to an embodiment, a method for workflow analysis comprises receiving, at an evaluation module executing on a processor, a plurality of execution logs including records of workflow paths traversed in a workflow, receiving, at the evaluation module executing on the processor, outcomes for the workflow paths traversed based on a target metric, correlating, by the evaluation module executing on the processor, at least one workflow step of the workflow with the target metric, and generating, by the evaluation module executing on the processor, an importance score for the at least one workflow step based on the correlation with the target metric.

According to an embodiment, the method may further comprise generating, by the evaluation module executing on the processor, a list of work steps identified for improvement based on importance scores for the workflow steps.

According to an embodiment, the method may further comprise receiving, at the evaluation module executing on the processor, the target metric.

According to an embodiment, correlating, by the evaluation module executing on the processor, at least one workflow step with the target metric may include correlating a history of workflow steps with the target metric by computing workflow branches that include a common root workflow step.

According to an embodiment, correlating, by the evaluation module executing on the processor, at least one workflow step with the target metric may include correlating a segment of workflow steps with the target metric.

According to an embodiment, the evaluation module may include a discrimination model including a statistical classifier.

According to an embodiment, the method may further comprise modifying, the workflow based on the importance score generated for the at least one workflow step.

According to an embodiment, the outcomes for the workflow paths traversed are provided to the evaluation module separately from the workflow paths traversed.

According to an embodiment, the target metric may include at least one of first call resolutions, handling time, escalations, customer churn, technician dispatches, customer satisfaction, net promoter score, inappropriate dispatches, no fault found, calling rate, repeat calls, or any other metric that may measure the results of workflow.

According to an embodiment, a system for workflow analysis comprises a processor comprising an evaluation module executing thereon and a log input in communication with the processor. The log input may be adapted to provide execution logs to the evaluation module, the execution logs including records of workflow paths traversed. The system may further comprise a metric input in communication with the processor and adapted to provide a target metric to the evaluation module. The evaluation module correlates one or more workflow steps of the workflow paths traversed with the target metric and generates an importance score for the at least one workflow step of the one or more workflow steps based on the correlation with the target metric.

According to an embodiment, the evaluation module may include a discrimination model including a statistical classifier.

According to an embodiment, a computerized method for workflow analysis comprises receiving, at an evaluation module executing on a processor, a plurality of sessions including execution logs with records of workflow paths traversed in a workflow and outcomes, partitioning, by the evaluation module executing on the processor, the sessions into a first category and a second category based on a target metric, searching for one or more steps in the workflow where the ratio of the first category to the second category changes, and generating, by the evaluation module executing on the processor, an importance score for at least one workflow step of the one or more workflow steps based on the correlation with the target metric.

According to an embodiment, the computerized method may further comprise generating, by the evaluation module executing on the processor, a list of work steps identified for improvement based on importance scores for the workflow steps.

According to an embodiment, the computerized method may further comprise receiving, at the evaluation module executing on the processor, the target metric.

According to an embodiment, searching, by the evaluation module executing on the processor, for one or more steps in the workflow where the ratio of the first category to the second category changes includes searching a history of workflow steps based on the target metric by computing workflow branches that include a common root workflow step.

According to an embodiment, searching, by the evaluation module executing on the processor, for one or more steps in the workflow where the ratio of the first category to the second category changes includes searching for a segment of workflow steps based on the target metric.

According to an embodiment, the evaluation module may include a discrimination model including a statistical classifier.

According to an embodiment, the computerized method may further comprise modifying, by an improvement module executing on the processor, the workflow based on the importance score generated for the at least one workflow step.

According to an embodiment, the outcomes are provided to the evaluation module separately from the workflow paths traversed.

According to an embodiment, the target metric may include at least one of first call resolutions, handling time, escalations, customer churn, technician dispatches, customer satisfaction, net promoter score, inappropriate dispatches, no fault found, calling rate, repeat calls, or any other metric that may measure the results of workflow.

These and other embodiments will become apparent in light of the following detailed description herein, with reference to the accompanying drawings.

### BRIEF DESCRIPTION OF THE DRAWINGS

FIG. 1 is a schematic diagram of a computerized system according to an embodiment;

FIG. 2 is flow diagram of an embodiment for providing workflow analysis with the system of FIG. 1;

FIG. 3 is an exemplary embodiment of a workflow for analysis by the system of FIG. 1;

FIG. 4 is a graphical representation of an embodiment of a prefix tree generated by the system of FIG. 1; and

FIG. 5 is a flow diagram of an embodiment for generating the prefix tree of FIG. 4.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

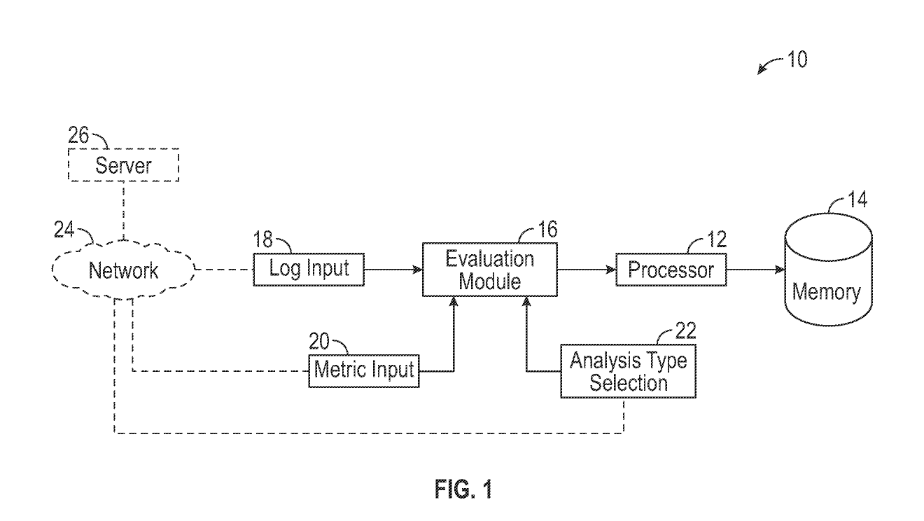

Referring to FIG. 1, a computerized system 10 for workflow analysis is shown. The computerized system 10 includes at least one processor 12, memory 14, and an evaluation module 16 adapted to be executed by the at least one processor 12. The evaluation module 16 includes a log input 18 and may also include a metric selection input 20 and/or an analysis type selection 22. One or more of the log input 18, metric selection input 20, and analysis type selection 22 may be operatively connected to a network 24 and or one or more servers 26. The evaluation module 16 receives execution logs providing records of workflow paths traversed in a workflow and provides analysis of said workflow.

The computerized system 10 includes the necessary electronics, software, memory, storage, databases, firmware, logic/state machines, microprocessors, communication links, and any other input/output interfaces to perform the functions described herein and/or to achieve the results described herein. For example, the computerized system 10 may include one or more processors and memory, such as the processor 12 and memory 24, which may include system memory, including random access memory (RAM) and read-only memory (ROM). Suitable computer program code may be provided to the computerized system 10 for executing numerous functions, including those discussed in connection with the evaluation module 16. For example, in some embodiments, the evaluation module 16 may be stored in memory 14 and may be executed and/or accessed by the processor 12. In other embodiments, the evaluation module 16 may be stored remotely and executed and/or accessed via one or more remote computing devices, such as a server over a network, as should be understood by those skilled in the art.

The one or more processors, such as the processor 12, may include one or more conventional microprocessors and may also include one or more supplementary co-processors such as math co-processors or the like. The one or more processors may be configured to communicate with other networks and/or devices such as servers, other processors, computers, cellular telephones, tablets and the like.

The one or more processors, including the processor 12, may be in communication with the memory 14, which may comprise magnetic, optical and/or semiconductor memory, such as, for example, random access memory (“RAM”), read only memory (“ROM”), flash memory, optical memory, or a hard disk drive memory. Memory 14 may store execution logs input and/or recorded therein for access by the log input 18 and/or may store execution logs input through the log input 18 for use by the evaluation module 16. The memory may also store any other information typically found in computing devices, including an operating system, and/or one or more other programs (e.g., computer program code and/or a computer program product) that are stored in a non-transitory memory portion and adapted to direct the computerized system 10 to perform according to the various embodiments discussed herein. The evaluation module 16 and/or other programs may be stored, for example, in a compressed format, an uncompiled and/or an encrypted format, and may include computer program code executable by the one or more processors, such as the processor 12. The executable instructions of the computer program code may be read into a main memory, such as memory 14, of the one or more processors, such as the processor 12, from a non-transitory computer-readable medium other than the memory 14. While execution of sequences of instructions in the program causes the one or more processors to perform the process steps described herein, hard-wired circuitry may be used in place of, or in combination with, executable software instructions for implementation of the processes of the present invention. Thus, embodiments of the present invention are not limited to any specific combination of hardware and software.

For example, the methods and programs discussed herein may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as providing workflow analysis. In an embodiment, an application of executable code may be a compilation of many instructions, which may be distributed over several different code partitions or segments, among different programs, and across several devices.

The term “computer-readable medium” as used herein refers to any medium that provides or participates in providing instructions and/or data to the one or more processors of the computerized system 10 (or any other processor of a device described herein) for execution. Such a medium may take many forms, including but not limited to, non-volatile media or memory and volatile memory. Non-volatile memory may include, for example, optical, magnetic, or opto-magnetic disks, or other non-transitory memory. Volatile memory may include dynamic random access memory (DRAM), which typically constitutes the main memory or other transitory memory.

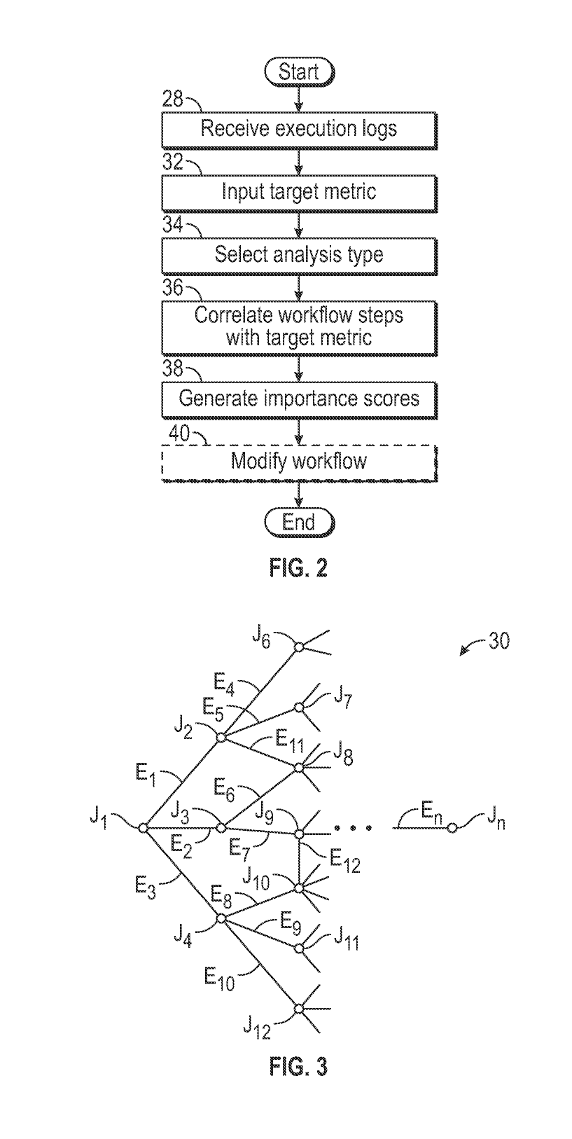

Referring to FIG. 2, in operation, the evaluation module 16, shown in FIG. 1, receives the execution logs at step 28 through the log input 18, shown in FIG. 1. The execution logs may be provided at regular intervals, such as hourly, daily, weekly, monthly or any other time interval, or may be provided on a real-time basis. In embodiments, the execution logs may be recorded locally in memory 14, shown in FIG. 1, with the log input 18, shown in FIG. 1, accessing the execution logs directly therefrom. In other embodiments, the log input 18, shown in FIG. 1, may be operatively connected to a network 24, shown in FIG. 1, and or one or more servers 26, shown in FIG. 1, where the execution logs may initially be stored and provided therefrom to the log input 18, shown in FIG. 1. The execution logs provide records of workflow paths traversed in a workflow 30, shown in FIG. 3, by agents for customer interactions. In embodiments, the workflow path information provided in the execution logs may be stored in a database from which various dumps may be taken and stored separately. For example, target metrics for each session may be stored separately in these dumps and the separate sessions may be retrieved and combined before being provided to the evaluation module 16, shown in FIG. 1. In other embodiments, the target metrics from different sessions may be combined directly in the database and provided therefrom to the evaluation module 16, shown in FIG. 1.

Referring to FIG. 3, an exemplary workflow 30 is shown. The workflow 30 is a set of steps. For instance, the workflow 30 may be a step of steps to guide agents, such as customer service representatives, sales representatives, service technicians or the like, through interactions with customers. Similarly, the workflow 30 may be a self-service workflow, where a customer is using a web site and each step in the workflow 30 is a web page. Additionally, in embodiments, the workflow 30 may be a business process workflow, where each step describes how employees should solve a subproblem and, some amount of time later, e.g. days or weeks, someone verifies that the subproblem has been solved, at which point the workflow determines the next subproblem. The steps may be represented by nodes Jᵢ and edges Eᵢ connecting the nodes Jᵢ. As the agent interacts with a customer, they progress through the workflow from one node Jᵢ to another node Jᵢ along the edges Eᵢ. Each workflow path is a particular sequence of steps, i.e. nodes Jᵢ and edge Eᵢ, in the workflow 30 that are executed consecutively. For example, an exemplary workflow path may be nodes and edges J₁, E₃, J₄, E₈, J₁₀, . . . , Eₙ, Jₙ. As agents interact with customers, the workflow paths traversed are recorded in execution logs. These execution logs may be provided to the evaluation module 16, shown in FIG. 1, through the log input 18, shown in FIG. 1, at step 28. The workflow 30 is provided for illustrative purposes and it should be understood by those skilled in the art that workflows may be significantly larger and more complex than the illustrative workflow 30 shown in FIG. 3.

Referring back to FIG. 2, at step 32, a target metric to which the workflow 30, shown in FIG. 3, is to be optimized is input to the evaluation module 16, shown in FIG. 1. The target metric may be input, for example, directly through the metric selection input 20, shown in FIG. 1, or may be provided to the evaluation module 16, shown in FIG. 1, over the network 24, shown in FIG. 1, from the server 26, shown in FIG. 1. In other embodiments, the evaluation module 16, shown in FIG. 1, may have one or more predefined target metrics for which each analysis is set to run. The target metrics may be, for example, first call resolutions, handling time, escalations, customer churn, technician dispatches, customer satisfaction, net promoter score, inappropriate dispatches, no fault found, calling rate, repeat calls or any other metric that may be affected by the workflow 30 or that may measure the results of workflow 30. For instance, customer satisfaction and net promoter score represent two different ways of scoring customer survey results, for example, where customers are asked for a 1 to 10 rating. Inappropriate dispatch and no fault found may refer to dispatching a technician inappropriately for a problem that did not require such a dispatch or where there is no problem at all, respectively. Target metrics may be identified or obtained from customer relationship management (CRM) data recorded by the agent, from dispatch logs or the like.

At step 34, an analysis type is selected for the workflow analysis. The analysis type may be input, for example, directly through the analysis type selection 22, shown in FIG. 1, or may be provided to the evaluation module 16, shown in FIG. 1, over the network 24, shown in FIG. 1, from the server 26, shown in FIG. 1. In other embodiments, the evaluation module 16, shown in FIG. 1, may have one or more predefined analysis types for which each analysis is set to run. The analysis type may be, for example, a branch node analysis, a prefix tree analysis, an N-gram discrimination analysis, or any other similar workflow analytic technique.

In embodiments, the system 10 may include a graphical user interface that includes one or more of the log input 18, the metric input 20 and/or the analysis type selection 22. The graphical user interface may, therefore, allow a user to select and input the data in the latest execution logs or some older set of executions logs, a desired metric for analysis and/or the type of analysis to be performed. Since, as discussed above, the execution logs may be preprocessed and stored in the various databases and/or dumps discussed above, in some embodiments, the log input 18 may instead allow a user to select which sessions, dumps and/or portions of databases to look at. Additionally, as discussed below, in embodiments, prefix trees of workflow path information may be constructed in advance and, therefore, log input 18 of the graphical user interface may allow the user to select which prefix trees to use in the analysis.

At step 36, the evaluation module 16, shown in FIG. 1, correlates the workflow steps of the workflow paths in the execution logs with the target metric using the selected analysis type. This evaluation module 16, shown in FIG. 1, utilizes the session execution logs of the workflow execution to provide a summary feedback on nodes and/or workflow paths that have large potential impact on the target metric.

At step 38, the evaluation module 16, shown in FIG. 1, generates metric or importance scores for the workflow steps in the analysis based on the correlation with the target metric. Workflow steps that lead to inferior metric or importance scores may be identified for workflow improvement. In embodiments, the metric or importance scores and associated workflow steps may be generated as a list and provided to workflow designers, for example, over network 24, shown in FIG. 1. At step 40, the workflow may then be modified, for example, by the workflow designers by targeting the workflow steps having higher importance scores. The modifications may include, for example, enhancement or alteration of workflow steps, compression of workflow steps, addition of workflow steps and/or elimination of workflow steps.

The particular analysis implemented by the evaluation module 16, shown in FIG. 1, for correlating the workflow steps with the target metric is dependent upon the selected analysis type. For example, in an embodiment, the evaluation module 16, shown in FIG. 1, may perform a branch node analysis to correlate a single workflow step with the target metric. The branch node analysis considers individually each node J in the workflow graph 30, shown in FIG. 3, that has multiple outgoing edges E. The evaluation module 16, shown in FIG. 1, counts, from a collection of execution logs, the number of sessions ever reaching the particular node J under analysis, and the number of sessions visiting each of the outgoing edges E leaving the node J. The evaluation module 16, shown in FIG. 1, determines a merit or importance score measuring a change in the proportions of good/bad sessions across this node J, where the good and bad labels are based on the target metric. For instance, if the target metric is customer churn, the bad label may be applied to a session resulting in a customer churning, while the good label may be applied to a session resulting in a customer remaining with the provider. Similarly, if the target metric is first call resolutions, the bad label may be applied to repeated calls, while the good label may be applied to non-repeated calls. Edges E that experience larger changes in the proportion of good/bad sessions as compared to the proportion of good/bad sessions at the node J receive greater metric or importance scores than edges E that experience smaller changes because the change in proportion provides an indication that the node J and edge E has a more significant effect on the target metric.

In an exemplary embodiment, the merit or importance score may be determined as a Child Rate Difference M (J, E) quantifying the difference between good/bad sessions of node J and edge E. The Child Rate Difference M (J, E) may be given as:

$$M ( J , E ) = \vert \frac{E ( B ) + ρ J ( B )}{E ( B ) + ( E ( G ) + ρ ( J ( B ) + J ( G ) )} - \frac{J ( B )}{J ( B ) + J ( G )} \vert$$

where:
ρ=w*{square root over (1/J(B)+1/J(G)))};
J(B) is the count of bad sessions through node J;
J(G) is the count of good sessions through node J;
E(B) is the count of bad sessions along edge E;
E(G) is the count of good sessions along edge E; and
w is a weighting factor.

If M (J, E) is large, the edge E out of node J has the most effect on whether a session will be good or bad. Thus, the Child Rate Difference M (J, E) may provide the merit or importance score discussed above. This analysis may be repeated for one or more nodes J and edges E in the workflow 30, shown in FIG. 3, to provide a plurality of merit or importance scores for the workflow steps of the workflow. The ρ parameter defines a level at which the evaluation module 16, shown in FIG. 1, determines if counts of good and/or bad sessions are statistically significant and, therefore, the weighting factor w may be adjusted to reduce or enhance the effect of the ρ parameter. For example, in some embodiments, the weighting factor w may be 1.

In another exemplary embodiment, the merit or importance score may be determined as the Information Gain IG(J, E), such that, if:

l(χ)=−χlog₂(χ)+(χ−1) log₂(1−χ); and

ρ=w*\sqrt{1J(B)+1/J(G)};

penalized Information Gain IG(J, E) may be given by:

$$IG ( J , E ) = I ( \frac{J ( B )}{J ( B ) + J ( G )} ) {\sum }_{i} ( \frac{{\tilde{E}}_{i} ( B )}{{\tilde{E}}_{i} ( B ) + {\tilde{E}}_{i} ( G )} ) I ( \frac{{\tilde{E}}_{i} ( B )}{{\tilde{E}}_{i} ( B ) + {\tilde{E}}_{i} ( G )} )$$

$$where \text{:}$$

$${\tilde{E}}_{i} ( B ) = {E}_{i} ( B ) + \frac{J ( B ) ρ ( {E}_{i} ( B ) + {E}_{i} ( G ) )}{J ( B ) + J ( G )} ; and$$

$${\tilde{E}}_{i} ( G ) = {E}_{i} ( G ) + \frac{J ( G ) ρ ( {E}_{i} ( B ) + {E}_{i} ( G ) )}{J ( B ) + J ( G )} .$$

Although Child Rate Difference M (J, E) and Information Gain IG(J, E) have been provided as exemplary merit or importance scores, other measures with a similar intent may implemented in the evaluation module 16, shown in FIG. 1, and, regardless of the measure implemented, the evaluation module 16, shown in FIG. 1, may return a list of branch nodes J sorted in the order of the merit or importance score at step 38.

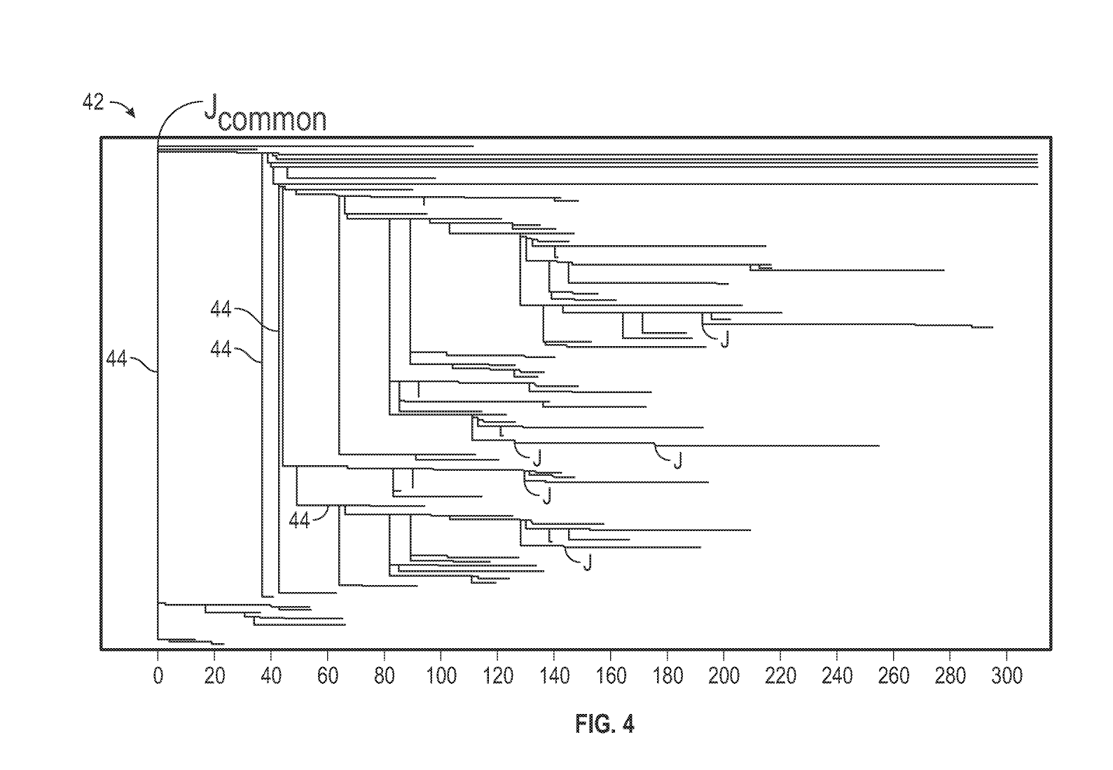

Referring to FIG. 4, in an embodiment, the evaluation module 16, shown in FIG. 1, may also perform a prefix tree analysis to correlate a history of workflow steps with the target metric by computing a prefix tree 42. The input to the prefix tree construction is a collection of workflow sessions from execution logs, where each session is a sequence of nodes J that describe a path 44 through the workflow 30, shown in FIG. 3. With the prefix tree analysis, the evaluation module 16, shown in FIG. 1, selectively considers only workflow sessions in the execution logs that arrive at particular nodes J by way of similar paths 44 through the workflow when determining the merit or importance score for the particular nodes J.

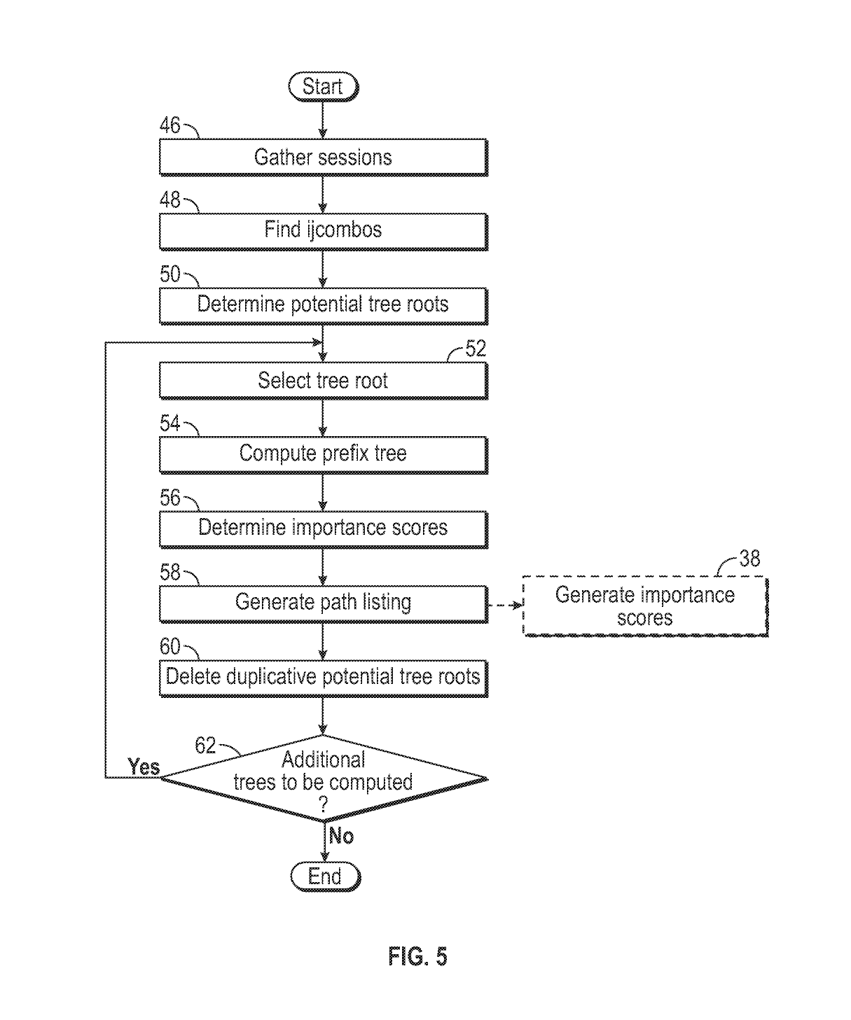

Referring to FIG. 5, to perform the prefix tree analysis, at step 46, the evaluation module 16, shown in FIG. 1, first gathers sessions beginning with a common step, i.e. a common node J_{common}, shown in FIG. 4, but diverging to different paths 44, shown in FIG. 4, after the common step or node J_{common}, shown in FIG. 4. For example, since each session includes a sequence of nodes J, with subsequent nodes being offset into the session, the evaluation module 16, shown in FIG. 1, may define an “ijcombo” providing a session number, an offset into the session for a particular node J, and a session tail defined as a sequence of the rest of the nodes in the session beginning at the offset. Thus, the set of all occurrences of some particular node J in the input data is a set of ijcombos. At step 48, for each possible node J, the evaluation module 16, shown in FIG. 1, may find all the ijcombos where the node J occurs in the execution logs. At step, 50, the evaluation module 16, shown in FIG. 1, may determine a list of potential tree roots by sorting the results of step 48 by decreasing popularity to provide a list whose first entry is the node J that has the most ijcombos. The node J for the most popular potential root being defined as the node J_{common}. At step 52, the evaluation module 16, shown in FIG. 1, selects the most popular potential root, removes it from the list, and considers the session tails for its ijcombos.

At step 54, the evaluation module 16, shown in FIG. 1, then computes the prefix tree 42, shown in FIG. 4, representing the splitting of paths 44, as defined by the session tails, beyond each branch point node J defined by the workflow graph and visited by a session beginning with the common step or node J_{common}, shown in FIG. 4. For example, the evaluation module 16, shown in FIG. 1, may lexicographically sort the session tails from step 52, which provides a tree that branches each time the session tails disagree. All of the session tails pass through the tree root at the common node J_{common}, shown in FIG. 4, so the tree branching breaks the set of session tails into smaller and smaller subsets. In some embodiments, the evaluation module 16, shown in FIG. 1, may prune the tree when the number of session tails falls to some fixed lower bound, such as 25, 50, 100 or any other value that is predefined in the evaluation module 16, shown in FIG. 1, as the lower bound.

Each workflow session in the execution logs is tagged as good or bad based on the target metric. For instance, if the customer called back within 3 days of an initial call, the session might be labeled bad for a first call resolution target metric. The number of sessions and counts of good and bad sessions among the sessions, are tracked in each branch of the tree by the evaluation module 16, shown in FIG. 1, and, at step 56, the evaluation module, 16, shown in FIG. 1, determines merit or importance scores across each splitting node J in the prefix tree using only the sessions for the prefix tree. For instance, the merit score may be the Child Rate Difference M (J, E) discussed above, the Information Gain IG(J, E) discussed above, or any other similar measure. At step 58, the evaluation module 16, shown in FIG. 1, generates a listing of paths 44 in the order of the merit or importance score, where each path 44 specifies the steps from the root node J_{common} and up to the evaluated splitting node J, and this listing may be output as the list of step 38 of FIG. 2 correlating the workflow steps to the target metric.

Additionally, once the tree is built for the tree root passing through the common node J_{common}, shown in FIG. 4, at step 60, the evaluation module 16, shown in FIG. 1, may determine if any of the potential tree roots determined at step 50 are substantially accounted for in the tree beginning with the common node J_{common}, shown in FIG. 4, to avoid the generation of subsequent duplicative prefix trees. For example, the evaluation module 16, shown in FIG. 1, may compare the number of session tails that reach each branch of the tree with the popularity of potential tree roots determined at step 50. If a single tree branch accounts for a predefined percentage of a potential tree root's ijcombos, e.g. 80%, 90%, 95% or any other preset value, the evaluation module 16, shown in FIG. 1, may remove that potential tree root from the list of potential tree roots so that the evaluation module 16, shown in FIG. 1, does not subsequently generate a substantially duplicative tree for that potential tree root.

At step 62, the evaluation module 16, shown in FIG. 1, may return to the list of potential tree roots and repeat steps 52 through 58 to generate another prefix tree 42 for the next most popular potential tree root. In some embodiments, the evaluation module 16, shown in FIG. 1, may only return to the list of potential tree roots and continue to generate prefix trees 42 if the most popular remaining potential tree root has at least some minimum number of ijcombo occurrences preset in the evaluation module 16, shown in FIG. 1. The minimum number of ijcombo occurrences may be, for example, 100, 250, 500 or any other selected value. If there are no remaining potential tree roots or no remaining potential tree roots having the minimum number of occurrences, the evaluation module 16, shown in FIG. 1, may stop constructing prefix trees 42.

Thus, with prefix tree analysis, the evaluation module 16, shown in FIG. 1, generates merit or importance scores for nodes J based on the target metric using only the workflow sessions in the execution logs that arrive at the nodes J by way of similar paths 44, shown in FIG. 4, through the workflow. Although construction of the prefix trees has been described in connection with the evaluation module 16, shown in FIG. 1, and the generation of importance scores, in embodiments, the prefix trees of workflow path information may be constructed in advance to simply processing by the evaluation module 16, shown in FIG. 1. If the prefix trees are constructed in advance, the evaluation module 16, shown in FIG. 1, may all a user to select which prefix trees to use in the analysis through the log input 18, shown in FIG. 1, and may generate the importance scores, as discussed above, for the selected prefix trees.

Referring back to FIG. 2, in an embodiment, the evaluation module 16, shown in FIG. 1, may correlate the workflow steps with the target metric using an n-gram discrimination analysis of the of workflow steps at step 36. N-gram discrimination may be implemented to correlate a segment of workflow steps with the target metric, without requiring a substantially common history of workflow steps as in the prefix tree analysis. In the n-gram discrimination analysis, the evaluation module 16, shown in FIG. 1, analyzes short sequences (n-grams) of workflow steps for their contributions in a discrimination model for good versus bad sessions. The n-grams may be sequences that include two or more nodes, such as the sequence of nodes (J₃, J₉, J₁₀), shown in FIG. 3. Additionally, in embodiments, the evaluation module 16, shown in FIG. 1, may perform the n-gram discrimination analysis on individual workflow steps including only single nodes J. The discrimination model may include a standard statistical classifiers such as a logistic regression model, support vector machine or the like that is trained with occurrence vectors of the n-grams as computed from session samples. Each occurrence vector represents how many times a session visited each of the considered sequences of steps. Each vector is assigned a class label for whether the session is good or bad according to the chosen target metric. The trained discrimination model specifies a coefficient for each component of the n-gram occurrence vector according to its contribution to the discrimination. If a particular n-gram or sequence of nodes appears in a high number of good sessions, that n-gram is assigned a high positive relative contribution score. Similarly, if the particular n-gram or sequence of nodes appears in a high number of bad sessions, that n-gram is assigned a high negative relative contribution score. N-grams appearing in sessions that result in more mixed good and bad results will be assigned lower positive or negative relative contribution scores. Thus, using the trained discrimination model, the evaluation module 16, shown in FIG. 1, is able to identify n-grams or sequences of nodes that appear in high numbers of good and bad sessions. For example, if the exemplary sequence of nodes (J₃, J₉, J₁₀) appears in a high number of good sessions in the execution logs, the sequence is assigned a high positive relative contribution score, whereas a second exemplary sequence of nodes (J₁, J₄, J₁₀) appearing in a high number of bad labels is assigned a low relative contribution score.

At step 38, the evaluation module 16, shown in FIG. 1, returns a list of n-grams (step sequences) sorted by their relative contribution to the discrimination model, with the relative contribution representing the merit or importance score. Both the high positive and high negative scores may represent n-grams of particular interest or hotspots for workflow modification and optimization.

Although branch node analysis, prefix tree analysis and N-gram discrimination have been described above as exemplary analysis techniques for correlating workflow steps with target metrics, it should be understood by those skilled in the art that other analysis techniques may be selected and implemented by the evaluation module 16, shown in FIG. 1, to provide correlations.

The merit or importance scores provide valuable input for workflow designers to modify and/or update workflows by allowing the workflow designers to target metrics that achieve specific business objectives. Thus, the system 10, shown in FIG. 1, advantageously provides advanced workflow analytics for identifying, improving and optimizing workflow based on issues that matter most to customers. The workflow analysis provided by the system 10, shown in FIG. 1, may advantageously increase first call resolution, decrease average call handling time, reduce escalations, reduce customer churn, reduce technician dispatch, improve customer satisfaction, increase net promoter score, reduce inappropriate dispatches, reduce no fault found returns, reduce calling rate, reduce repeat calls and/or provide similar improvements in other customer care metrics.

The system 10, shown in FIG. 1, may advantageously enhance the customer experience by assisting service provides with developing optimal customer care workflows for care agents, self-service, and other care channels by summarizing workflow paths traversed as recorded in the execution logs and evaluating their impacts. For example, the system 10, shown in FIG. 1, may be implemented by telecommunication customer service providers and the like. Advantageously, each analysis technique of the system 10, shown in FIG. 1, represents workflow paths in a different way to score the importance of workflow paths with respect to the chosen metric. The scores identify which workflow paths may be enhanced, altered, compressed, eliminated or the like to improve the workflow.

The system 10, shown in FIG. 1, advantageously provides an automated system for determining the importance of workflow paths, which could not be done manually for the entire workflow for a variety of reasons including time, computation, and workflow information constraints. The system 10, shown in FIG. 1, may be fully automated and may cover all possible and realized workflow paths. The system 10, shown in FIG. 1, may also advantageously provide an interactive tool for workflow analysis. The system 10, shown in FIG. 1, may advantageously handle a large quantity of workflow sessions per day across thousands of workflows.

Although this invention has been shown and described with respect to the detailed embodiments thereof, it will be understood by those skilled in the art that various changes in form and detail thereof may be made without departing from the spirit and the scope of the invention.

What is claimed is:

1. A method for workflow analysis comprising:
receiving, at an evaluation module executing on a processor, a plurality of execution logs including records of workflow paths traversed in a workflow;
receiving, at the evaluation module executing on the processor, outcomes for the workflow paths traversed based on a target metric;
correlating, by the evaluation module executing on the processor, at least one workflow step of the workflow with the target metric; and
generating, by the evaluation module executing on the processor, an importance score for the at least one workflow step based on the correlation with the target metric.

2. The method according to claim 1, further comprising:
generating, by the evaluation module executing on the processor, a list of work steps identified for improvement based on importance scores for the workflow steps.

3. The method according to claim 1, further comprising:
receiving, at the evaluation module executing on the processor, the target metric.

4. The method according to claim 1, wherein correlating, by the evaluation module executing on the processor, at least one workflow step with the target metric includes correlating a history of workflow steps with the target metric by computing workflow branches that include a common root workflow step.

5. The method according to claim 1, wherein correlating, by the evaluation module executing on the processor, at least one workflow step with the target metric includes correlating a segment of workflow steps with the target metric.

6. The method according to claim 1, wherein the evaluation module includes a discrimination model including a statistical classifier.

7. The method according to claim 1, further comprising:
modifying, the workflow based on the importance score generated for the at least one workflow step.

8. The method according to claim 1, wherein the outcomes for the workflow paths traversed are provided to the evaluation module separately from the workflow paths traversed.

9. The method according to claim 1, wherein the target metric includes at least one of first call resolutions, handling time, escalations, customer churn, technician dispatches, customer satisfaction, net promoter score, inappropriate dispatches, no fault found, calling rate, or repeat calls.

10. A system for workflow analysis, the system comprising:
a processor, the processor comprising an evaluation module executing thereon;
a log input in communication with the processor, the log input adapted to provide execution logs to the evaluation module including records of workflow paths traversed; and
a metric input in communication with the processor, the metric input adapted to provide a target metric to the evaluation module;
wherein the evaluation module correlates one or more workflow steps of the workflow paths traversed with the target metric and generates an importance score for the at least one workflow step of the one or more workflow steps based on the correlation with the target metric.

11. The system according to claim 10, wherein the evaluation module includes a discrimination model including a statistical classifier.

12. A computerized method for workflow analysis comprising:
receiving, at an evaluation module executing on a processor, a plurality of sessions including execution logs with records of workflow paths traversed in a workflow and outcomes;
partitioning, by the evaluation module executing on the processor, the sessions into a first category and a second category based on a target metric;
searching for one or more steps in the workflow where the ratio of the first category to the second category changes; and
generating, by the evaluation module executing on the processor, an importance score for at least one workflow step of the one or more workflow steps based on the correlation with the target metric.

13. The computerized method according to claim 12, further comprising:
generating, by the evaluation module executing on the processor, a list of work steps identified for improvement based on importance scores for the workflow steps.

14. The computerized method according to claim 12, further comprising:
receiving, at the evaluation module executing on the processor, the target metric.

15. The method according to claim 12, wherein searching, by the evaluation module executing on the processor, for one or more steps in the workflow where the ratio of the first category to the second category changes includes searching a history of workflow steps based on the target metric by computing workflow branches that include a common root workflow step.

16. The method according to claim 12, wherein searching, by the evaluation module executing on the processor, for one or more steps in the workflow where the ratio of the first category to the second category changes includes searching for a segment of workflow steps based on the target metric.

17. The method according to claim 12, wherein the evaluation module includes a discrimination model including a statistical classifier.

18. The computerized method according to claim 12, further comprising:
modifying, by an improvement module executing on the processor, the workflow based on the importance score generated for the at least one workflow step.

19. The computerized method according to claim 12, wherein the outcomes are provided to the evaluation module separately from the workflow paths traversed.

20. The computerized method according to claim 12, wherein the target metric includes at least one of first call resolutions, handling time, escalations, customer churn, technician dispatches, customer satisfaction, net promoter score, inappropriate dispatches, no fault found, calling rate, or repeat calls.
